(19) United States
(12) Patent Application Publication
(10) Pub. No.: US 2017/0371888 A1
(43) Pub. Date: Dec. 28, 2017

(54) METHOD FOR ADVERTISEMENT INTERCEPTION IN DUAL-KERNEL BROWSER AND BROWSER APPARATUS

(71) Applicant: BEIJING QIHOO TECHNOLOGY COMPANY LIMITED, Beijing (CN)

(72) Inventor: Xiaobin ZONG, Beijing (CN)

(21) Appl. No.: 15/540,015

(22) PCT Filed: Nov. 27, 2015
(86) PCT No.: PCT/CN2015/095817

§ 371 Date: Jun. 26, 2017

(30) Foreign Application Priority Data
Dec. 27, 2014 (CN) 201410836075.3

(51) Int. Cl. G06F 17/30

(52) U.S. Cl. CPC G06F 17/3089; G06F 17/30887

(57) ABSTRACT

A method and an apparatus for advertisement interception in a dual-kernel browser. The method comprises: detecting that an IE kernel webpage subprocess and/or a Webkit kernel webpage subprocess in a dual-kernel browser loads webpage information according to a webpage access request; intercepting and suspending the webpage access request, wherein the webpage access request comprises a webpage address information URL; and when a browser main process determines that the webpage access request in the IE kernel webpage subprocess and/or the Webkit kernel webpage subprocess is a request for advertisement-type webpage information, abandoning the webpage access request in the IE kernel webpage subprocess and/or the Webkit kernel webpage subprocess. In this way, opening an advertisement webpage is prevented fundamentally, so that clean webpage content is provided for a user and network resources are saved.

### FIELD OF TECHNOLOGY

The present invention relates to the field of Internet technologies, and in particular, to a method for advertisement interception in a dual-kernel browser and a dual-kernel browser apparatus.

### BACKGROUND

Browsers refer to software that can display HTML (HyperText Mark-up Language) file contents of web servers or file systems and allow users to interact with these files. The browsers interact with the web serves primarily via HTTP protocols and obtain webpages, which are specified by URL, generally have a file format of HTML, and specified in the HTTP protocols by MIME.

With the development of network technologies, different layout formats appear in webpages. Therefore, browsers with different kernels are generated to parse and display the webpages. To facilitate users browsing webpages, dual-kernel browsers emerge to parse and display different webpages using different kernels.

### SUMMARY

In view of the above problems, the present invention is proposed to provide a method for sending recommendation information and a corresponding apparatus for sending recommendation information to overcome or at least partially solve the above problems.

According to an aspect of the present invention, there is provided a method for advertisement interception in a dual-kernel browser. The method comprises: detecting that an IE kernel webpage subprocess and/or a Webkit kernel webpage subprocess in a dual-kernel browser loads webpage information according to a webpage access request; intercepting and suspending the webpage access request, wherein the webpage access request comprises a webpage address information URL; and when a browser main process determines that the webpage access request in the IE kernel webpage subprocess and/or the Webkit kernel webpage subprocess is a request for advertisement-type webpage information, abandoning the webpage access request in the IE kernel webpage subprocess and/or the Webkit kernel webpage subprocess.

According to another aspect of the present invention, there is provided a dual-kernel browser apparatus, which comprises: a request monitoring module, configured to detect that an IE kernel webpage subprocess and/or a Webkit kernel webpage subprocess in a dual-kernel browser loads webpage information according to a webpage access request; a request intercepting module, configured to intercept and suspend the webpage access request, wherein the webpage access request comprises a webpage address information URL; and an intercepting module, configured to abandon the webpage access request in the IE kernel webpage subprocess and/or the Webkit kernel webpage subprocess when a browser main process determines that the webpage access request in the IE kernel webpage subprocess and/or the Webkit kernel webpage subprocess is a request for advertisement-type webpage information.

According to still another aspect of the present invention, there is provided a program, which includes a readable code. When the readable code runs on a computing device, the computing device is caused to execute the method for advertisement interception in a dual-kernel browser according to the embodiments of the present invention.

According to still another aspect of the present invention, there is provided a readable medium, in which the program of the embodiments of the present invention is stored.

When the dual-kernel browser sends a webpage access request to load corresponding webpage information using the IE kernel webpage subprocess and/or the Webkit kernel webpage subprocess, the webpage access request is intercepted and suspended, so that the webpage subprocess is prevented from directly loading the webpage information returned based on the webpage access request. Next, advertisement resource verification is performed on the webpage access request by the browser main process, and only webpage information of the webpage access request succeeded in verification can be loaded. The webpage access request failed in verification is directly abandoned, and the webpage information of the webpage access request is not returned to the requested webpage subprocess. In this way, opening an advertisement webpage is prevented fundamentally, so that clean webpage content is provided for a user and network resources are saved.

Described above is merely an overview of a technical solution of the present invention. In order to more apparently understand the technical means of the present invention to implement in accordance with the contents of specification, and to more readily understand above and other objectives, features and advantages of the present invention, specific embodiments of the present invention are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the present invention. Further, throughout the drawings, same elements are indicated by same reference numbers. In the drawings:

FIG. 1 illustrates a step flowchart of a method embodiment for advertisement interception in a dual-kernel browser according to an embodiment of the present invention;

FIG. 2 illustrates a step flowchart of a method embodiment for advertisement interception by a Webkit kernel webpage subprocess in a dual-kernel browser according to an embodiment of the present invention;

FIG. 3 illustrates a step flowchart of a method embodiment for advertisement interception by an IE kernel webpage subprocess in a dual-kernel browser according to an embodiment of the present invention;

FIG. 4 illustrates a structural block diagram of a dual-kernel browser apparatus according to an embodiment of the present invention;

FIG. 5 illustrates a preferred structural block diagram of a dual-kernel browser apparatus embodiment according to an embodiment of the present invention;

FIG. 6 illustrates a structural block diagram of a resource verification module in a dual-kernel browser apparatus embodiment according to an embodiment of the present invention;

FIG. 7 illustrates a structural block diagram of a content verification module in a dual-kernel browser apparatus embodiment according to an embodiment of the present invention;

FIG. 8 illustrates a block diagram of a computing device for executing the method for advertisement interception in a dual-kernel browser according to the present invention; and

FIG. 9 illustrates a memory unit for maintaining or carrying a program code for implementing the method for advertisement interception in a dual-kernel browser according to the present invention.

### DESCRIPTION OF THE EMBODIMENTS

The following will describe in more detail the exemplary embodiments of the present invention with reference to the accompanying drawings. Although the accompanying drawings display the exemplary embodiments of the present invention, it should be understood that the present invention may be implemented in various forms but not limited by the embodiments set forth herein. Rather, these embodiments are provided so that this disclosure will be understood thoroughly and completely and will fully convey the scope of the present invention to those skilled in the art.

### Embodiment I

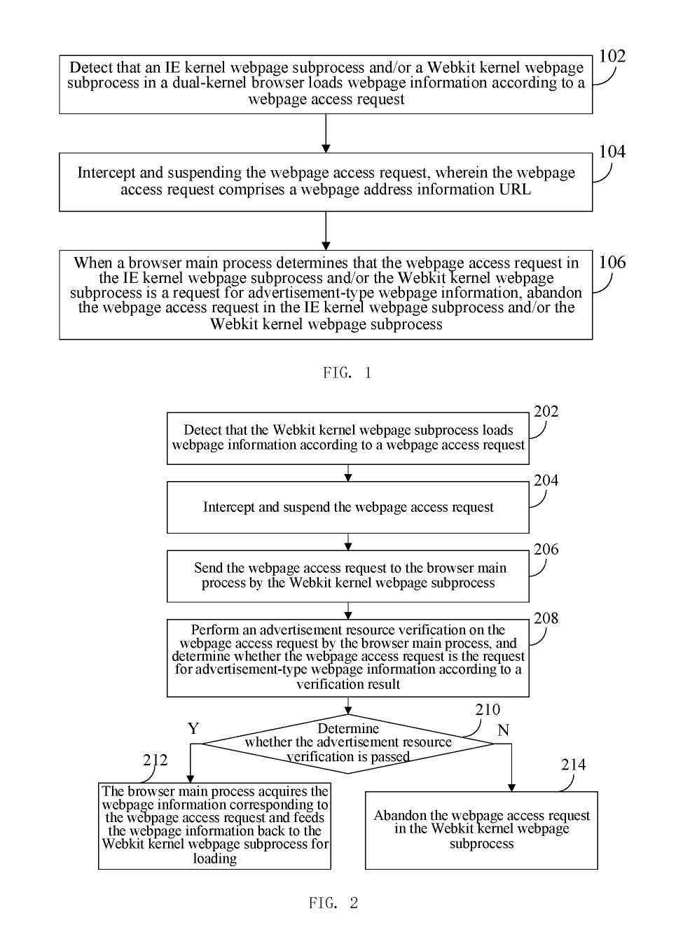

Referring to FIG. 1, which illustrates a step flowchart of a method embodiment for advertisement interception in a dual-kernel browser according to an embodiment of the present invention, the method may include following steps.

Step 102: detecting that an IE kernel webpage subprocess and/or a Webkit kernel webpage subprocess in a dual-kernel browser loads webpage information according to a webpage access request.

A kernel refers to a rendering engine of a browser. In this embodiment, the dual-kernel browser includes an Internet Explorer (IE) kernel and a Webkit kernel. The IE kernel actually uses a webcontrol of a Microsoft operating system as a kernel, for example, the IE kernel may adopt a Trident engine. The WebKit is an open source browser engine.

When opening a webpage, the dual-kernel browser may start, based on different webpage layout formats, different kernel webpage subprocesses to start the corresponding webpages. Since most of current webpages have advertisement pushing, a user may see the advertisement after opening the webpages, which is inconvenient for the user to browse the webpage content. Therefore, in this embodiment, a webpage opened in the dual-kernel browser is intercepted. By monitoring the IE kernel webpage subprocess and the Webkit kernel webpage subprocess in the dual-kernel browser, it may be detected that the IE kernel webpage subprocess loads webpage information according to the webpage access request, and/or the Webkit kernel webpage subprocess loads the webpage information according to the webpage access request.

Step 104: intercepting and suspending the webpage access request, wherein the webpage access request comprises a webpage address information URL.

No matter the IE kernel webpage subprocess or the Webkit kernel webpage subprocess in the dual-kernel browser loads the webpage information according to the webpage access request, the webpage access request is intercepted and suspended, that is, the webpage access request is intercepted. The webpage access request includes a webpage address information URL (Uniform Resource Locator).

Step 106: when a browser main process determines that the webpage access request in the IE kernel webpage subprocess and/or the Webkit kernel webpage subprocess is a request for advertisement-type webpage information, abandoning the webpage access request in the IE kernel webpage subprocess and/or the Webkit kernel webpage subprocess.

In this embodiment, to intercept advertisements in the request load webpage, the webpage subprocess is prevented from directly loading the webpage information via the webpage access request, instead, advertisement resource verification is performed on the webpage access request by the browser main process. When it is verified that the webpage access request is a request for advertisement-type webpage information, this represents that the current webpage access request is a request for advertisement webpage. In this case, the webpage access request should be abandoned, and the webpage information thereof is not returned to the requested IE kernel webpage subprocess and/or the Webkit kernel webpage subprocess for loading.

In conclusion, when the dual-kernel browser sends a webpage access request to load corresponding webpage information using the IE kernel webpage subprocess and/or the Webkit kernel webpage subprocess, the webpage access request is intercepted and suspended, so that the webpage subprocess is prevented from directly loading the webpage information returned based on the webpage access request. Next, advertisement resource verification is performed on the webpage access request by the browser main process, and only webpage information of the webpage access request succeeded in verification can be loaded. The webpage access request failed in verification is directly abandoned, and the webpage information of the webpage access request is not returned to the requested webpage subprocess. In this way, opening an advertisement webpage is prevented fundamentally, so that clean webpage content is provided for a user and network resources are saved.

The dual-kernel browser in this embodiment of the present disclosure comprises an IE kernel and a Webkit kernel. Webpage subprocesses having different kernels may be different in advertisement interception.

### Embodiment II

Based on the foregoing embodiment, this embodiment elaborates steps of intercepting advertisement information in webpages by means of the Webkit kernel webpage subprocess in the dual-kernel browser.

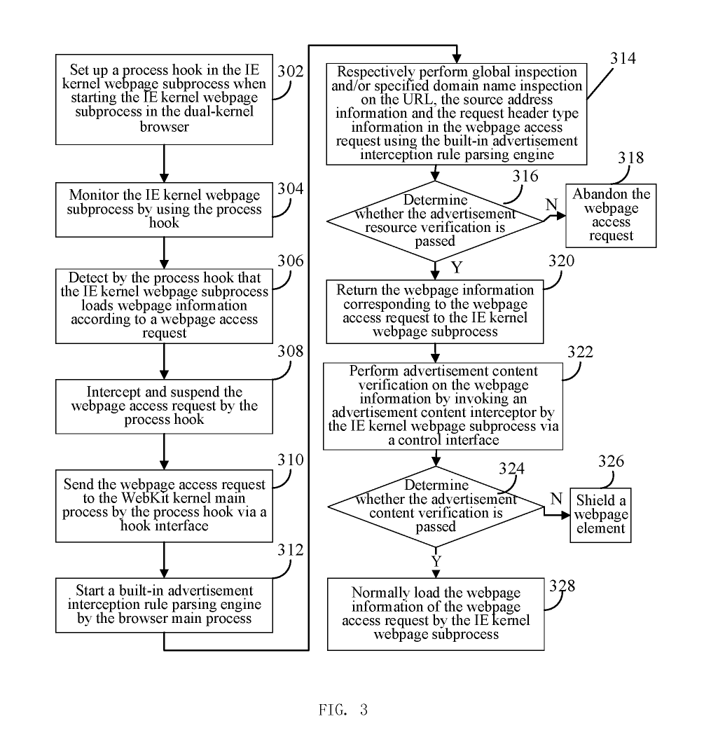

Referring to FIG. 2, which illustrates a step flowchart of a method embodiment for advertisement interception by a Webkit kernel webpage subprocess in a dual-kernel browser according to an embodiment of the present invention, the method specifically may include following steps.

Step 202: detecting that the Webkit kernel webpage subprocess loads webpage information according to a webpage access request.

Step 204: intercepting and suspending the webpage access request.

Step 206: sending the webpage access request to the browser main process by the Webkit kernel webpage subprocess.

The dual-kernel browser sends the webpage access request using the Webkit kernel webpage subprocess to load webpage information, intercepts and suspends the webpage access request, and transmits the webpage access request to the browser main process serving as a proxy. The browser main process in this embodiment may be based on the IE kernel or may be based on the Webkit kernel. Taking a Webkit kernel main process as an example, the Webkit kernel webpage subprocess may send the webpage access request to the Webkit kernel main process serving as a proxy instead of directly sending the webpage access request to a network. The Webkit kernel main process determines whether to allow the Webkit kernel webpage subprocess to load the webpage information based on the webpage access request.

Step 208: performing an advertisement resource verification on the webpage access request by the browser main process, and determining whether the webpage access request is the request for advertisement-type webpage information according to a verification result.

Step 210: determining whether the advertisement resource verification is passed.

In this embodiment, the webpage access request comprises: URL information, source address information and request header type information. The URL information is a webpage address of a requested webpage. As a part of an http request header, the source address information (i.e., refer), also referred to as HTTP Referer, is used for representing the address of a page. When the browser sends a request to the web server, generally the Referer is carried to inform the server that from which page the request is linked. The request header type information (i.e., accept-type) is an accept type carried in the http request header.

In an alternative embodiment of the present invention, the performing an advertisement resource verification on the webpage access request by the browser main process comprises: starting a built-in advertisement interception rule parsing engine by the browser main process; and respectively performing global inspection and/or specified domain name inspection of advertisement resources on the URL, the source address information and the request header type information in the webpage access request using the built-in advertisement interception rule parsing engine.

In this embodiment, an integrated advertisement interception rule parsing engine is built in the browser main process, so that the browser main process detects, in sequence, the URL, the source address information and the request header type information using the built-in advertisement interception rule parsing engine, wherein the advertisement interception detection rule includes a global rule and a specified domain name rule.

The global rule refers to performing matching inspection on all URLs, the source address information and the request header type information according to the rule. When the detection matches the global rule, this represents that what is requested is advertisement resource information, and the advertisement resource verification is not passed.

The specified domain name rule refers to an advertisement matching rule for a webpage access request whose domain name is specified. The corresponding domain name may be parsed via the URL in the webpage access request, and then the matching rule of the domain name is acquired to perform matching detection on the URL, the source address information and the request header type information in sequence. When the detection matches the specified domain name rule, this represents that what is requested is advertisement resource information, and the advertisement resource verification is not passed.

When the URL, the source address information and the request header type information in the webpage access request neither match the global rule nor match the specified domain name rule, the advertisement resource verification is passed.

In an alternative embodiment of the present invention, the step of respectively performing specified domain name inspection of advertisement resources on the URL, the source address information and the request header type information in the webpage access request using the built-in advertisement interception rule parsing engine comprises: acquiring the URL, the source address information and the request header type information from the webpage access request by the built-in advertisement interception rule parsing engine in sequence; determining a website of the URL and acquiring a filter of the website; filtering the URL, the source address information and the request header type information respectively by using the filter of the website; and determining whether the advertisement resource verification is passed according to filtering results.

For detection of the specified domain name rule, in this embodiment, a filter corresponding to the rule may be preconfigured for detection. The step of generating the filter includes: acquiring, in sequence by the built-in advertisement interception rule parsing engine, an interception rule file of each website from an interception rule base at a network side; and respectively parsing the interception rule file of the each website to generate the filter of the each website.

An interception rule base of an advertisement matching rule of each website is maintained in the network. Therefore, the built-in advertisement interception rule parsing engine may periodically acquire, from the network, the interception rule base to acquire an interception rule file of each website. For each interception rule file, a filter for advertisement interception is generated by parsing for the corresponding website. In this way, domain-name-based interception matching is implemented for each website using the interception rule file thereof

After generating the filter, the built-in advertisement interception rule parsing engine parses the URL, the source address information and the request header type information, then determines the domain name of the website according to the URL, determines the filter matching the domain name, and then filters the URL, the source address information and the request header type information in sequence using the filter to determine whether it is the same as the interception rule configured in the interception rule file. The advertisement resource verification is not passed when it is the same as the interception rule. Otherwise, the advertisement resource verification is passed.

Step 212: the browser main process acquires the webpage information corresponding to the webpage access request and feeds the webpage information back to the Webkit kernel webpage subprocess for loading.

After the advertisement resource verification is passed, the URL is not the request for the advertisement page. Therefore, the browser main process normally acquires the webpage information corresponding to the webpage access request, and then feeds the webpage information back to the Webkit kernel webpage subprocess so that the Webkit kernel webpage subprocess loads the webpage information to display the corresponding webpage.

Step 214: abandoning the webpage access request in the Webkit kernel webpage subprocess.

When the advertisement resource verification is not passed, the URL is the request for the advertisement page. The browser main process abandons using the webpage access request webpage resource. The browser main process may not feed any information back to the Webkit kernel webpage subprocess, or may feed a message that cannot be opened by the webpage to the Webkit kernel webpage subprocess.

In conclusion, an advertisement interception rule parsing engine is built in the browser main process, so that the built-in advertisement interception rule parsing engine in the browser main process may be directly employed to perform global inspection and/or domain name inspection on the webpage access request of each webpage subprocess, thereby accurately detecting and abandoning a request for advertisement webpage.

Next, a filter of each website may be generated based on an interception rule file of each website in the interception rule base of the network, so that when detecting based on a domain name, the URL, the source address information and the request header type information are filtered by a filter selected based on determination of the domain name of the URL, thereby completing advertisement resource verification.

### Embodiment III

When the user opens a webpage in the browser, sometimes the webpage carries an independent advertisement page. Therefore, the requested independent advertisement page may be intercepted and prohibited from displaying through the above mentioned way. However, some advertisements are embedded into the normal content of a webpage. When the URLs of these advertisements are directly intercepted, this may cause that the entire webpage cannot be displayed, which is apparently neither reasonable not desirable.

Therefore, this embodiment further provides a step of intercepting an advertisement embedded into the normal content of a webpage. In this embodiment, an IE kernel webpage subprocess is taken as an example for discussion.

Referring to FIG. 3, which illustrates a step flowchart of a method embodiment for advertisement interception by an IE kernel webpage subprocess in a dual-kernel browser according to an embodiment of the present invention, the method specifically may include following steps.

Step 302: setting up a process hook in the IE kernel webpage subprocess when starting the IE kernel webpage subprocess in the dual-kernel browser.

Step 304: monitoring the IE kernel webpage subprocess by using the process hook.

In this embodiment, the browser main process adopts a WebKit kernel main process. The IE kernel webpage subprocess cannot directly communicate with the WebKit kernel main process. Therefore, a hook is required for implementing interaction between the IE kernel webpage subprocess and the WebKit kernel main process.

A process hook may be set up in an IE kernel webpage subprocess when starting the IE kernel webpage subprocess in the dual-kernel browser. The hook mechanism allows an application program to intercept and process a window message or a particular event. The process hook may monitor various messages of the IE kernel webpage subprocess.

Step 306: detecting by the process hook that the IE kernel webpage subprocess loads webpage information according to a webpage access request.

Step 308: intercepting and suspending the webpage access request by the process hook.

When detecting the IE kernel webpage subprocess sends a webpage access request to request to load webpage information, the process hook intercepts the webpage access request and temporarily suspends the webpage access request instead of sending the webpage access request to the network.

Step 310: sending the webpage access request to the WebKit kernel main process by the process hook via a hook interface.

Step 312: starting a built-in advertisement interception rule parsing engine by the browser main process.

The process hook sends the webpage access request to the WebKit kernel main process via the hook interface. The WebKit kernel main process may start the built-in advertisement interception rule parsing engine to detect the webpage access request of an advertisement page.

In this embodiment, the advertisement interception rule parsing engine comprises Adblock or Adblock Plus. The Adblock allows the user to intercept various page elements including advertisement pages, and ensures these contents to be neither downloaded nor displayed. As a branch of the Adblock, the Adblock Plus may block objects such as images or Flash on particular websites and webpages. A wildcard character or a regular expression may be used in a filter to block all advertisements, and by default, the Adblock Plus may filter all annoying advertisements on a webpage, including video advertisements on YouTube and Facebook, dazzling banner advertisements, pop-up windows, hidden pop-up windows and more advertisements.

The webpage access request of the IE kernel webpage subprocess may be detected by the Webkit kernel main process, wherein the webpage access request includes the URL, the source address information and the request header type information. In this way, the objective of blocking a request for an advertisement page is implemented.

Step 314: respectively performing global inspection and/or specified domain name inspection of advertisement resources on the URL, the source address information and the request header type information in the webpage access request using the built-in advertisement interception rule parsing engine.

Step 316: determining whether the advertisement resource verification is passed.

The built-in advertisement interception rule parsing engine detects, in sequence, the URL, the source address information and the request header type information, wherein the advertisement interception detection rule includes a global rule and a specified domain name rule.

The global rule refers to performing matching inspection on all URLs, the source address information and the request header type information according to the rule. When the detection matches the global rule, this represents that what is requested is advertisement resource information, and the advertisement resource verification is not passed.

The specified domain name rule refers to an advertisement matching rule for a webpage access request whose domain name is specified. The corresponding domain name may be parsed via the URL in the webpage access request, and then the matching rule of the domain name is acquired to perform matching detection on the URL, the source address information and the request header type information in sequence. When the detection matches the specified domain name rule, this represents that what is requested is advertisement resource information, and the advertisement resource verification is not passed.

When the URL, the source address information and the request header type information in the webpage access request neither match the global rule nor match the specified domain name rule, the advertisement resource verification is passed.

In an alternative embodiment of the present invention, the step of respectively performing specified domain name inspection of advertisement resources on the URL, the source address information and the request header type information in the webpage access request using the built-in advertisement interception rule parsing engine comprises: acquiring the URL, the source address information and the request header type information from the webpage access request by the built-in advertisement interception rule parsing engine in sequence; determining a website of the URL and acquiring a filter of the website; filtering the URL, the source address information and the request header type information respectively by using the filter of the website; and determining whether the advertisement resource verification is passed according to filtering results.

For detection of the specified domain name rule, in this embodiment, a filter corresponding to the rule may be preconfigured for detection. The step of generating the filter includes: acquiring, in sequence by the built-in advertisement interception rule parsing engine, an interception rule file of each website from an interception rule base at a network side; and respectively parsing the interception rule file of the each website to generate the filter of the each website.

An interception rule base of an advertisement matching rule of each website is maintained in the network. Therefore, the built-in advertisement interception rule parsing engine may periodically acquire, from the network, the interception rule base to acquire an interception rule file of each website. For each interception rule file, a filter for advertisement interception is generated by parsing for the corresponding website. In this way, domain-name-based interception matching is implemented for each website using the interception rule file thereof

After generating the filter, the built-in advertisement interception rule parsing engine parses the URL, the source address information and the request header type information, then determines the domain name of the website according to the URL, determines the filter matching the domain name, and then filters the URL, the source address information and the request header type information in sequence using the filter to determine whether it is the same as the interception rule configured in the interception rule file. The advertisement resource verification is not passed when it is the same as the interception rule. Otherwise, the advertisement resource verification is passed.

Step 318: abandoning the webpage access request in the IE kernel webpage subprocess.

When the advertisement resource verification is not passed, the URL is the request for the advertisement page. The browser main process abandons using the webpage access request webpage resource. The browser main process may not feed any information back to the IE kernel webpage subprocess, or may feed a message that cannot be opened by the webpage to the IE kernel webpage subprocess.

Step 320: returning the webpage information corresponding to the webpage access request to the IE kernel webpage subprocess.

Step 322: performing advertisement content verification on the webpage information by invoking an advertisement content interceptor by the IE kernel webpage subprocess via a control interface.

After the advertisement resource verification is passed, the webpage access request is not the request for the advertisement webpage. However, to improve the accuracy in advertisement filtering, some advertisements may be hidden in normal webpage contents, and directly abandoning these advertisements may cause the user cannot browse normal webpage contents.

Therefore, when the webpage access request succeeds in the advertisement resource verification, a suspending operation on the webpage access request may be ended, the corresponding webpage information is requested from the network, and then the acquired webpage information is returned to the IE kernel webpage subprocess.

To intercept advertisements hidden in a webpage, the IE kernel webpage subprocess may use an advertisement content interceptor, which includes a cascading style sheets (CSS) selector. The CSS selector may implement control of elements in an HTML page, including implementing one-to-one, one-to-more or more-to-one control of the elements in the HTML page.

The IE kernel webpage subprocess invokes the advertisement content interceptor via the control interface and performs advertisement content verification on the webpage information using the advertisement content interceptor.

In a preferred embodiment of the present invention, the invoking an advertisement content interceptor by the IE kernel webpage subprocess via a control interface to perform advertisement content verification on the webpage information comprises: invoking the advertisement content interceptor by the IE kernel webpage subprocess via the control interface to acquire an advertisement hiding rule table; checking, by the IE kernel webpage subprocess, whether the webpage element specified in the webpage information conforms to an advertisement hiding condition in the advertisement hiding rule table; and determining that the advertisement content verification is not passed when the specified webpage element conforms to the advertisement hiding condition in the advertisement hiding rule table.

The IE kernel webpage subprocess invokes an advertisement content interceptor via the control interface (for example, a WebBrowser interface), acquires the advertisement hiding rule table using the advertisement content interceptor, and then detects whether a webpage element in the webpage matches the advertisement hiding rule table, namely, using the webpage element specified in the webpage information to match the corresponding advertisement hiding condition in the advertisement hiding rule table. It is determined that the advertisement content verification is not passed when the specified webpage element conforms to the advertisement hiding condition in the advertisement hiding rule table. Otherwise, it is determined that the advertisement content verification is passed when the specified webpage element does not conform to the advertisement hiding condition in the advertisement hiding rule table.

Optionally, the invoking the advertisement content interceptor by the IE kernel webpage subprocess via the control interface to acquire an advertisement hiding rule table comprises: invoking the advertisement content interceptor by the IE kernel webpage subprocess using the control interface; acquiring a domain name of the webpage address information URL by the advertisement content interceptor, and matching the advertisement hiding rule table by using the domain name; and receiving, by the IE kernel webpage subprocess via the control interface, the advertisement hiding rule table fed back by the advertisement content interceptor.

The IE kernel webpage subprocess invokes the advertisement content interceptor using the control interface. The advertisement content interceptor acquires the URL transmitted by the IE kernel webpage subprocess, analyzes the domain name of the URL, then uses the domain name to match the corresponding advertisement hiding rule table, and then sends the advertisement hiding rule table to the IE kernel webpage subprocess via the control structure, so that the IE kernel webpage subprocess detects the webpage element in the webpage information based on the advertisement hiding rule table.

Step 324: determining whether the advertisement content verification is passed.

Step 328 is executed when the advertisement content verification is passed; otherwise Step 328 is executed.

Step 326: shielding, by the IE kernel webpage subprocess, a webpage element specified in the loaded webpage information.

It is determined that the advertisement content verification is not passed when the specified webpage element conforms to the advertisement hiding condition in the advertisement hiding rule table. The content corresponding to the webpage element that conforms to the advertisement hiding condition is advertisement information, the IE kernel webpage subprocess shields the webpage element specified in the loaded webpage information, and the specified webpage element is not loaded in the page.

Step 328: normally loading the webpage information of the webpage access request by the IE kernel webpage subprocess.

It is determined that the advertisement content verification of the specified webpage element succeeds when the specified webpage element does not conform to the corresponding advertisement hiding condition in the advertisement hiding rule table, and the specified webpage element may be normally loaded in the webpage, so that the webpage information succeeding in the advertisement content verification is loaded and displayed.

The above provide embodiments for intercepting and shielding, in the IE kernel webpage subprocess, the webpage element of an advertisement hidden in the webpage information. In concrete implementation, the Webkit kernel webpage subprocess may also intercept and shield the webpage element of an advertisement hidden in the webpage information, which is basically similar to the above process, and thus is not unnecessarily described.

In conclusion, a webpage access request failed in advertisement resource verification may be directly abandoned, and thus is not suitable for intercepting advertisements hidden in a normal webpage content. Therefore, advertisement content verification needs to be performed on a webpage access request succeeded in advertisement resource verification to prevent the webpage access request from hiding in a normal webpage content and thus being unable to intercept a URL, thereby improving accuracy in advertisement interception.

In the advertisement content verification, an advertisement hiding rule table is acquired by an advertisement content interceptor, so that webpage advertisement interception may be implemented based on a domain name, thereby ensuring the accuracy of interception.

It should be explained that, for a brief description, method embodiments are describe as a combination of a series of motions. However, those skilled in the art should know that the embodiments of the present invention are not limited by sequences of the motions described. This is because some steps may be performed by using other sequences or be performed simultaneously in accordance with the embodiments of the present invention. In addition, those skilled in the art should also learn that the embodiments described in the specification are preferred embodiments, and involved motions are not necessary for the embodiments of the present disclosure.

### Embodiment IV

Based on the foregoing embodiments, this embodiment further provides a dual-kernel browser apparatus, which comprises an IE (Internet Explorer) kernel and a Webkit kernel.

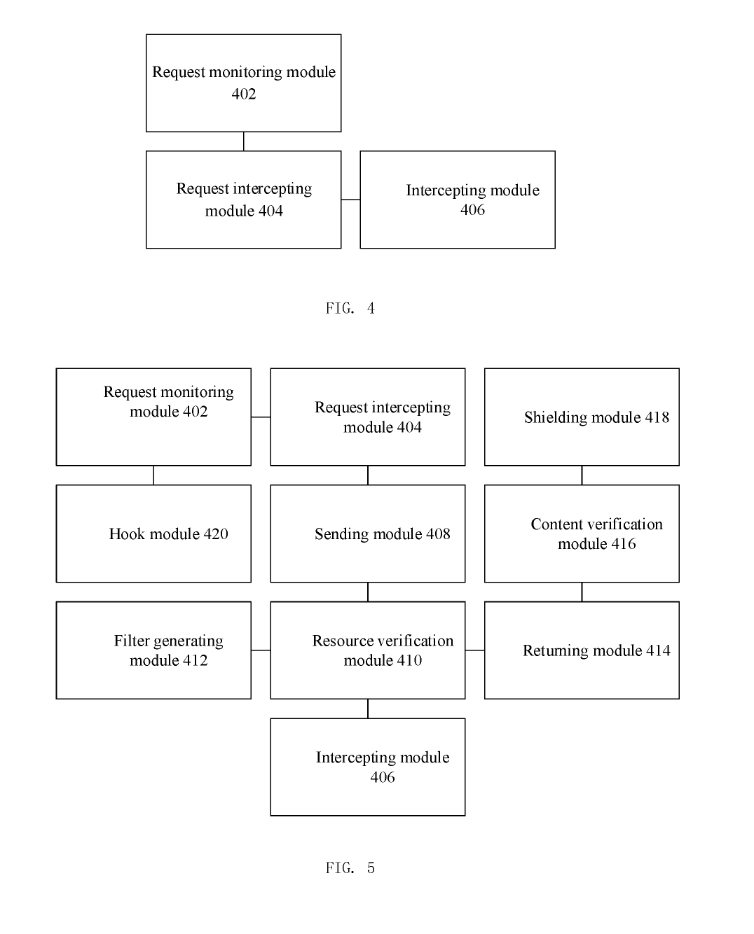

Referring to FIG. 4, which illustrates a structural block diagram of a dual-kernel browser apparatus embodiment according to an embodiment of the present invention, the dual-kernel browser apparatus may include following modules:
a request monitoring module 402, configured to detect that an IE kernel webpage subprocess and/or a Webkit kernel webpage subprocess in the dual-kernel browser loads webpage information according to a webpage access request;
a request intercepting module 404, configured to intercept and suspend the webpage access request, wherein the webpage access request comprises a webpage address information URL; and
an intercepting module 406, configured to abandon the webpage access request in the IE kernel webpage subprocess and/or the Webkit kernel webpage subprocess when a browser main process determines that the webpage access request in the IE kernel webpage subprocess and/or the Webkit kernel webpage subprocess is a request for advertisement-type webpage information.

When the dual-kernel browser sends a webpage access request to load corresponding webpage information using the IE kernel webpage subprocess and/or the Webkit kernel webpage subprocess, the webpage access request is intercepted and suspended, so that the webpage subprocess is prevented from directly loading the webpage information returned based on the webpage access request. Next, advertisement resource verification is performed on the webpage access request by the browser main process, and only webpage information of the webpage access request succeeded in verification can be loaded. The webpage access request failed in verification is directly abandoned, and the webpage information of the webpage access request is not returned to the requested webpage subprocess. In this way, opening an advertisement webpage is prevented fundamentally, so that clean webpage content is provided for a user and network resources are saved.

Referring to FIG. 5, which illustrates a preferred structural block diagram of a dual-kernel browser apparatus embodiment according to an embodiment of the present invention.

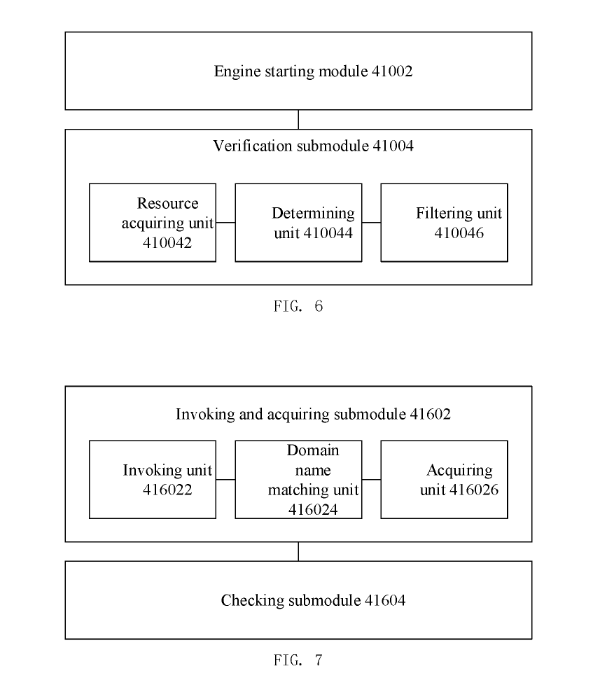

Referring to FIG. 6, which illustrates a structural block diagram of a resource verification module in a dual-kernel browser apparatus embodiment according to an embodiment of the present invention.

Referring to FIG. 7, which illustrates a structural block diagram of a content verification module in a dual-kernel browser apparatus embodiment according to an embodiment of the present invention.

In an alternative embodiment of the present invention, the dual-kernel browser apparatus further comprises: a sending module 408, configured to send the webpage access request to the browser main process by the IE kernel webpage subprocess and/or the Webkit kernel webpage subprocess; and a resource verification module 410, configured to perform an advertisement resource verification on the webpage access request by the browser main process, and determine whether the webpage access request is the request for advertisement-type webpage information according to a verification result.

The webpage access request further comprises: source address information and request header type information, and the resource verification module 410 comprises: an engine starting module 41002, configured to start a built-in advertisement interception rule parsing engine of the browser main process; and a verification submodule 41004, configured to respectively perform global inspection and/or specified domain name inspection of advertisement resources on the URL, the source address information and the request header type information in the webpage access request using the built-in advertisement interception rule parsing engine.

In an alternative embodiment of the present invention, the verification submodule 41004 comprises: a resource acquiring unit 410042, configured to acquire the URL, the source address information and the request header type information from the webpage access request by the built-in advertisement interception rule parsing engine in sequence; a determining unit 410044, configured to determine a website of the URL and acquire a filter of the website; and a filtering unit 410046, configured to filter the URL, the source address information and the request header type information respectively by using the filter of the website, and determine whether the advertisement resource verification is passed according to filtering results.

In an alternative embodiment of the present invention, the dual-kernel browser apparatus further comprises a filter generating module 412, configured to acquire, in sequence by the built-in advertisement interception rule parsing engine, an interception rule file of each website from an interception rule base at a network side, and generate the filter of each website by respectively parsing the interception rule file of the each website.

A returning module 414, configured to return the webpage information corresponding to the webpage access request to the IE kernel webpage subprocess when the advertisement resource verification is passed.

A content verification module 416, configured to perform advertisement content verification on the webpage information by invoking an advertisement content interceptor by the IE kernel webpage subprocess via a control interface.

A shielding module 418, configured to shield, by the IE kernel webpage subprocess, a webpage element specified in the loaded webpage information when determining that the advertisement content verification is not passed.

In an alternative embodiment of the present invention, the content verification module 416 comprises: an invoking and acquiring submodule 41602, configured to invoke the advertisement content interceptor by the IE kernel webpage subprocess via the control interface and acquire an advertisement hiding rule table; and a checking submodule 41604, configured to check, by the IE kernel webpage subprocess, whether the webpage element specified in the webpage information conforms to an advertisement hiding condition in the advertisement hiding rule table, and determine that the advertisement content verification is not passed when the specified webpage element conforms to the advertisement hiding condition in the advertisement hiding rule table.

The invoking and acquiring submodule 41602 comprises: an invoking unit 416022, configured to invoke the advertisement content interceptor by the IE kernel webpage subprocess by using the control interface; a domain name matching unit 416024, configured to acquire a domain name of the webpage address information URL by the advertisement content interceptor, and match the advertisement hiding rule table by using the domain name; and an acquiring unit 416026, configured to acquire, by the IE kernel webpage subprocess via the control interface, the advertisement hiding rule table fed back by the advertisement content interceptor.

The advertisement content interceptor comprises a cascading style sheets CSS selector. The advertisement interception rule parsing engine comprises Adblock or Adblock Plus.

In an alternative embodiment of the present invention, the browser main process comprises a WebKit kernel main process, and the apparatus further comprises: a hook module 418, configured to set up a process hook in the IE kernel webpage subprocess when starting the IE kernel webpage subprocess in the dual-kernel browser; and a request monitoring module 420, configured to monitor the IE kernel webpage subprocess by using the process hook to detect the webpage access request of the IE kernel webpage subprocess.

The sending module 408 is configured to send the webpage access request to the WebKit kernel main process by the process hook via a hook interface.

In conclusion, an advertisement interception rule parsing engine is built in the browser main process, so that the built-in advertisement interception rule parsing engine in the browser main process may be directly employed to perform global inspection and/or domain name inspection on the webpage access request of each webpage subprocess, thereby accurately detecting and abandoning a request for advertisement webpage.

Next, a filter of each website may be generated based on an interception rule file of each website in the interception rule base of the network, so that when detecting based on a domain name, the URL, the source address information and the request header type information are filtered by a filter selected based on determination of the domain name of the URL, thereby completing advertisement resource verification.

A webpage access request not passed in advertisement resource verification may be directly abandoned, and thus is not suitable for intercepting advertisements hidden in a normal webpage content. Therefore, advertisement content verification needs to be performed on a webpage access request succeeded in advertisement resource verification to prevent the webpage access request from hiding in a normal webpage content and thus being unable to intercept a URL, thereby improving accuracy in advertisement interception.

In the advertisement content verification, an advertisement hiding rule table is acquired by an advertisement content interceptor, so that webpage advertisement interception may be implemented based on a domain name, thereby ensuring the accuracy of interception.

Device embodiments are basically similar to method embodiments, so description of device embodiments is relatively simple. Please see method embodiments which may serve as reference.

Algorithm and display provided herein are not inherently related to a particular computer, virtual system or other equipment. Various general systems may also be used with the teaching based on the present invention. According to the above description, the required structure for constructing such a system is obvious. In addition, the present invention is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the present invention and to facilitate the understanding of one or more of various aspects thereof, in the above description of the exemplary embodiments of the present invention, various features of the present invention may sometimes be grouped together into a single embodiment, accompanying figure or description thereof. However, the method of this disclosure should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the present invention and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the method and apparatus for advertisement interception in a dual-kernel browser according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

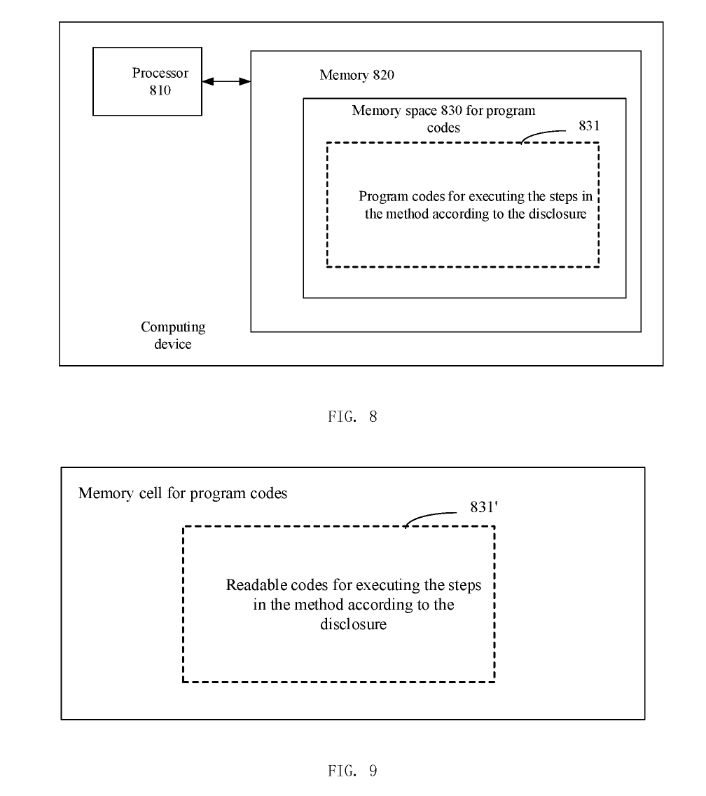

For example, FIG. 8 illustrates a computing device for implementing the method for advertisement interception in a dual-kernel browser according to the present invention. Traditionally, the computing device includes a processor 810 and a program product or a readable medium in form of a memory 820. The memory 820 could be electronic memories such as flash memory, EEPROM (Electrically Erasable Programmable Read-Only Memory), EPROM or ROM. The memory 820 has a memory space 830 for executing program codes 831 of any steps in the above methods. For example, the memory space 8930 for program codes may include respective program codes 831 for implementing the respective steps in the method as mentioned above. These program codes may be read from and/or be written into one or more program products. These program products include program code carriers such as memory card. These program products are usually the portable or stable memory cells as shown in reference FIG. 9. The memory cells may be provided with memory sections, memory spaces, etc., similar to the memory 820 of the computing device as shown in FIG. 8. The program codes may be compressed for example in an appropriate form. Usually, the memory cell includes readable codes 831′ which can be read for example by processors 810. When these codes are operated on the computing device, the computing device may execute respective steps in the method as described above.

It should be noted that the above-described embodiments are intended to illustrate but not to limit the present invention, and alternative embodiments can be devised by a person skilled in the art without departing from the scope of claims as appended. In the claims, no reference mark between round brackets shall impose restriction on the claims. The word “include/comprise” does not exclude a component or step not listed in the claims. The wording “a” or “an” in front of an element does not exclude the presence of a plurality of such elements. The present invention may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be construed as naming.

1. A method for advertisement interception in a dual-kernel browser, comprising:
detecting that an IE kernel webpage subprocess or a Webkit kernel webpage subprocess in a dual-kernel browser loads webpage information according to a webpage access request;
intercepting and suspending the webpage access request, wherein the webpage access request comprises a webpage address information URL; and
when a browser main process determines that the webpage access request in the IE kernel webpage subprocess or the Webkit kernel webpage subprocess is a request for advertisement-type webpage information, abandoning the webpage access request in the IE kernel webpage subprocess or the Webkit kernel webpage subprocess.

2. The method according to claim 1, wherein after the intercepting and suspending the webpage access request, the method further comprises:
sending the webpage access request to the browser main process by the IE kernel webpage subprocess or the Webkit kernel webpage subprocess; and
performing an advertisement resource verification on the webpage access request by the browser main process, and determining whether the webpage access request is the request for advertisement-type webpage information according to a verification result.

3. The method according to claim 2, wherein the webpage access request further comprises: source address information and request header type information, and the performing an advertisement resource verification on the webpage access request by the browser main process comprises:
starting a built-in advertisement interception rule parsing engine by the browser main process; and
respectively performing global inspection or specified domain name inspection of advertisement resources on the URL, the source address information and the request header type information in the webpage access request using the built-in advertisement interception rule parsing engine.

4. The method according to claim 3, wherein the step of respectively performing specified domain name inspection of advertisement resources on the URL, the source address information and the request header type information in the webpage access request using the built-in advertisement interception rule parsing engine comprises:
acquiring the URL, the source address information and the request header type information from the webpage access request by the built-in advertisement interception rule parsing engine in sequence;
determining a website of the URL and acquiring a filter of the website;
filtering the URL, the source address information and the request header type information respectively by using the filter of the website; and
determining whether the advertisement resource verification is passed according to filtering results.

5. The method according to claim 3, further comprising a step of generating the filter:
acquiring, in sequence by the built-in advertisement interception rule parsing engine, an interception rule file of each website from an interception rule base at a network side; and
respectively parsing the interception rule file of the each website to generate the filter of the each website.

6. The method according to claim 1, further comprising:
returning the webpage information corresponding to the webpage access request to the IE kernel webpage subprocess when the advertisement resource verification is passed;
performing advertisement content verification on the webpage information by invoking an advertisement content interceptor by the IE kernel webpage subprocess via a control interface; and
when determining that the advertisement content verification is not passed, shielding, by the IE kernel webpage subprocess, a webpage element specified in the loaded webpage information.

7. The method according to claim 6, wherein the performing advertisement content verification on the webpage information by invoking an advertisement content interceptor by the IE kernel webpage subprocess via a control interface comprises:
invoking the advertisement content interceptor by the IE kernel webpage subprocess via the control interface to acquire an advertisement hiding rule table;
checking, by the IE kernel webpage subprocess, whether the webpage element specified in the webpage information conforms to an advertisement hiding condition in the advertisement hiding rule table; and
determining that the advertisement content verification is not passed when the webpage information conforms to the advertisement hiding condition in the advertisement hiding rule table.

8. The method according to claim 7, wherein the invoking the advertisement content interceptor by the IE kernel webpage subprocess via the control interface to acquire an advertisement hiding rule table comprises:
invoking the advertisement content interceptor by the IE kernel webpage subprocess by using the control interface;
acquiring a domain name of the webpage address information URL by the advertisement content interceptor, and matching the advertisement content interceptor by using the domain name; and
receiving, by the IE kernel webpage subprocess via the control interface, the advertisement hiding rule table fed back by the advertisement content interceptor.

9.-10. (canceled)

11. The method according to claim 2, wherein the browser main process comprises a WebKit kernel main process, and the method further comprises:
setting up a process hook in the IE kernel webpage subprocess when starting the IE kernel webpage subprocess in the dual-kernel browser; and
monitoring the IE kernel webpage subprocess by using the process hook to detect the webpage access request of the IE kernel webpage subprocess.

12. The method according to claim 11, wherein the step of sending the webpage access request to the main process by the IE kernel webpage subprocess comprises:
sending the webpage access request to the WebKit kernel main process by the process hook via a hook interface.

13. A dual-kernel browser apparatus, comprising:
a memory having instructions stored thereon;.
a processor configured to execute the instructions to perform operations for advertisement interception, the operations comprising:
detecting that an IE kernel webpage subprocess or a Webkit kernel webpage subprocess in a dual-kernel browser loads webpage information according to a webpage access request;
intercepting and suspend the webpage access request, wherein the webpage access request comprises a webpage address information URL; and
abandoning the webpage access request in the IE kernel webpage subprocess or the Webkit kernel webpage subprocess when a browser main process determines that the webpage access request in the IE kernel webpage subprocess or the Webkit kernel webpage subprocess is a request for advertisement-type webpage information.

14. The apparatus according to claim 13, wherein the operations further comprise:
sending the webpage access request to the browser main process by the IE kernel webpage subprocess or the Webkit kernel webpage subprocess; and
performing an advertisement resource verification on the webpage access request by the browser main process, and determining whether the webpage access request is the request for advertisement-type webpage information according to a verification result.

15. The apparatus according to claim 14, wherein the webpage access request further comprises: source address information and request header type information, and the operation of performing an advertisement resource verification on the webpage access request by the browser main process comprises:
starting a built-in advertisement interception rule parsing engine of the browser main process; and
respectively performing global inspection or specified domain name inspection of advertisement resources on the URL, the source address information and the request header type information in the webpage access request using the built-in advertisement interception rule parsing engine.

16. The apparatus according to claim 15, wherein the operation of respectively performing global inspection or specified domain name inspection of advertisement resources on the URI, the source address information and the request header type information in the webpage access request using the built-in advertisement interception rule parsing engine.
acquiring the URL, the source address information and the request header type information from the webpage access request by the built-in advertisement interception rule parsing engine in sequence;
determining a website of the URL and acquire a filter of the website; and
filtering the URL, the source address information and the request header type information respectively by using the filter of the website, and determining whether the advertisement resource verification is passed according to filtering results.

17. The apparatus according to claim 15, wherein the operations further comprise:
acquiring, in sequence by the built-in advertisement interception rule parsing engine, an interception rule file of each website from an interception rule base at a network side, and respectively parsing the interception rule file of the each website to generate the filter of the each website.

18. The apparatus according to claim 13, wherein the operations further comprise:
returning the webpage information corresponding to the webpage access request to the IE kernel webpage subprocess when the advertisement resource verification is passed;
performing advertisement content verification on the webpage information by invoking an advertisement content interceptor by the IE kernel webpage subprocess via a control interface; and
shielding, by the IE kernel webpage subprocess, a webpage element specified in the loaded webpage information when determining that the advertisement content verification is passed.

19. The apparatus according to claim 18, wherein the operation of performing advertisement content verification on the webpage information by invoking an comprises:
invoking the advertisement content interceptor by the IE kernel webpage subprocess via the control interface and acquire an advertisement hiding rule table; and
checking, by the IE kernel webpage subprocess, whether the webpage element specified in the webpage information conforms to an advertisement hiding condition in the advertisement hiding rule table, and determining that the advertisement content verification is not passed when the specified webpage element conforms to the advertisement hiding condition in the advertisement hiding rule table.

20. The apparatus according to claim 19, wherein the operation of invoking the advertisement content interceptor by the IE kernel webpage subprocess via the control interface and acquire an advertisement hiding rule table comprises:
invoking the advertisement content interceptor by the IE kernel webpage subprocess by using the control interface;
acquiring a domain name of the webpage address information URL by the advertisement content interceptor, and matching the advertisement hiding rule table by using the domain name; and
acquiring, by the IE kernel webpage subprocess via the control interface, the advertisement hiding rule table fed back by the advertisement content interceptor.

21.-22. (canceled)

23. The apparatus according to claim 14, wherein the browser main process comprises a WebKit kernel main process, and the operations further comprise:
setting up a process hook in the IE kernel webpage subprocess when starting the IE kernel webpage subprocess in the dual-kernel browser; and
monitoring the IE kernel webpage subprocess by using the process hook to detect the webpage access request of the IE kernel webpage subprocess, and
the operation of sending the webpage access request to the browser main process by the the webpage access request to the WebKit kernel main process by the process hook via a hook interface.

24.-25. (canceled)

26. A non-transitory computer-readable medium having computer programs stored thereon that, when executed by one or more processors of a computing device, cause the computing device to perform operations for advertisement interception in a dual-kernel browser, the operations comprising.
detecting that an IE kernel webpage subprocess or a Webkit kernel webpage subprocess in a dual-kernel browser loads webpage information according to a webpage access request;
intercepting and suspending the webpage access request, wherein the webpage access request comprises a webpage address information URL; and
when a browser main process determines that the webpage access request in the IE kernel webpage subprocess or the Webkit kernel webpage subprocess is a request for advertisement-type webpage information, abandoning the webpage access request in the IE kernel webpage subprocess or the Webkit kernel webpage subprocess.
